(19) United States
(12) Patent Application Publication
(10) Pub. No.: US 2026/0331782 A1
(43) Pub. Date: Oct. 22, 2026

(54) RADAR ABSORBING WINDOW GLASS FOR VEHICLES

(71) Applicant: Toyota Motor Engineering & Manufacturing North America, Inc., Plano, TX (US)

(72) Inventors: John D. Harkleroad, Ypsilanti, MI (US); Trey M. Souchock, Saline, MI (US); William P. Dix, Highland Park, MI (US); Brian T. Clayson, South Lyon, MI (US); Christopher A. Sarros, Tecumseh (CA)

(73) Assignees: Toyota Motor Engineering & Manufacturing North America, Inc., Plano, TX (US); Toyota Jidosha Kabushiki Kaisha, Toyota-shi (JP)

(21) Appl. No.: 19/183,648

(22) Filed: Apr. 18, 2025

(51) Int. Cl. H01Q 17/00; B60J 1/08; B60J 1/20; G01S 13/56

(52) U.S. Cl. CPC H01Q 17/008; G01S 13/56; B60J 1/08; B60J 1/20

(57) ABSTRACT

Systems and vehicles with radar sensors and radar absorbing materials to improve performance of the radar sensors. A vehicle may include a radar sensor configured to detect a person in or a property of an interior of the vehicle, such as the presence of one or more passengers. Radar absorbing material (RAM) may be added on or embedded into a window of the vehicle in order to reduce noise received by the radar sensor to thereby improve performance of the radar sensor.

### BACKGROUND

### 1. Field

The present disclosure is generally directed to radar absorbing material (RAM) for vehicles, and more particularly to radar absorbing window glass for vehicles and methods of using the same.

### 2. Description of the Related Art

Radar systems may be used inside of vehicle cabins for occupant detection, classification, general cabin awareness, and other uses. Radar is good at detecting humans due to the high dielectric strength of water. However, when rain or other water nearby (e.g., condensation, windshield washer fluid, or snow) is sensed by the radar system, false readings may occur, resulting in inaccurate detection by the radar system.

Radar absorbing material (RAM) has been used in military applications and have more recently become available for automotive Advanced Driver Assistance Systems (ADAS). Current RAM(s) are limited to carbon-based materials, conductive polymers, magnetic materials, and resonant structures. RAMs can absorb radar waves, thereby decreasing reflective noise and other unwanted signals picked up by a radar system.

Current applications for RAM in the automotive industry focus on improving performance of exterior radar sensors, such as blind spot monitors. Current interior radar systems avoid being directed at window glass in order to prevent noise caused by unwanted sensor readings through or reflected by the window glass. Designing automotive radar sensor systems to avoid a vehicle's window glass can limit the field of sensor detection. For example, a vehicle passenger leaning towards his or her door or window may not be picked up by a passenger-detection radar system designed to avoid the vehicle's windows due to the passenger's close proximity to the window. By intentionally limiting the scope and range of the system to avoid erroneous readings, a radar system may be incapable of obtaining true readings in certain situations.

Therefore, there is a need for systems, vehicles, and methods for providing better and more accurate radar readings within vehicles.

### SUMMARY

Systems, vehicles, and methods for radar absorption within vehicles are disclosed herein. A vehicle may have a radar system that is configured to detect a person or a property of the interior of the vehicle, such as the presence of one or more passengers. The vehicle may have a cabin and windows, and the radar system may be positioned within the cabin of the vehicle for sensing persons and/or objects within the vehicle. One or more of the windows of the vehicle may be treated with or made with a radar absorbing material (RAM) that can absorb electromagnetic waves produced by the radar system. By absorbing electromagnetic waves from the radar system, the RAM can reduce signal noise that is generated from objects beyond the window (i.e., outside) of the vehicle. By reducing noise, the RAM can therefore increase the performance of the radar system.

### BRIEF DESCRIPTION OF THE DRAWINGS

Other systems, methods, features, and advantages of the present invention will be apparent to one skilled in the art upon examination of the following figures and detailed description. Component parts shown in the drawings are not necessarily to scale and may be exaggerated to better illustrate the important features of the present invention.

FIG. 1 illustrates a vehicle with a radar system, according to an aspect of the present disclosure;

FIG. 2 illustrates a radar system, according to an aspect of the present disclosure;

FIG. 3A illustrates a radar system in a vehicle without RAM, according to an aspect of the present disclosure; and

FIG. 3B illustrates a radar system in a vehicle with RAM, according to an aspect of the present disclosure.

### DETAILED DESCRIPTION

Described herein are systems, vehicles, and methods for improving radar systems in vehicles through the use of radar absorbing materials (RAMs). Noise from existing radar systems may be minimized by the use of one or more RAMs added in (e.g., embedded into) or onto the windows of vehicles. RAMs may include carbon-based materials like carbon composites and carbon nanotubes. These carbon composites and carbon nanotubes may be highly effective in absorbing radar waves. RAMs may also include conductive polymers, such as materials like polyaniline and polypyrrole, which can be used, for example, to create radar-absorbing coatings. Other RAM examples may include magnetic materials such as ferrites and other magnetic materials that can absorb radar signals by converting the electromagnetic energy of the radar waves into heat. Additionally, other RAMs may include resonant structures, which may have structures that resonate at specific radar frequencies and that can be designed to absorb those radar frequencies effectively. RAMs may also include other materials capable of absorbing radar signals, including absorbing and/or attenuating incoming electromagnetic waves and converting the electromagnetic wave energy into thermal energy or other forms of energy.

The introduction of signal noise into a radar system can degrade the performance of the system. Noise may include unwanted signals that interfere with the radar's ability to detect legitimate targets (e.g., humans). Noise degrades the accuracy and quality of data gathered by the radar sensor system. Radar system noise can be a combination of internal and external noise that can affect a radar's performance. Internal noise may be generated by the radar's electronic components, such as amplifiers and signal processors, as well as crosstalk between various components. Electromagnetic interference may also affect radar systems, as other electronic systems operating on similar frequencies may interfere with the radar system's ability to detect its intended target(s).

External noise may be caused by unwanted echoes from various objects. Water can interact negatively with radar systems, as rain water is highly conductive. Radar waves may be reflected or scattered when they come into contact with water. Rain or other water near a vehicle may interfere with the readings of a radar system if the radar waves come into contact with water. Radar signals or waves emitted from an interior vehicle radar system may come into contact with water if the radar signals pass through a vehicle window and there is rain or other water outside the vehicle, such as window condensation, windshield washer fluid, or snow or even a person outside of the vehicle.

Rain can interfere with radar signals because raindrops may reflect radar waves, leading to a decrease in the accuracy of the radar return signal. This can also interfere with the radar system's ability to correctly detect objects or features within its path. For a vehicle radar system, scattering of the radar waves can lead to the radar system being unable to detect people or objects within the vehicle, leading to a decrease in system performance. The overall safety of the vehicle may be affected as well, as many interior radar systems for vehicles relate to vehicle safety.

Interior radar systems in vehicles use one or more radar sensors placed inside the cabin of a vehicle. Sensors may, for example, be mounted in an overhead console or placed within a roof lining, although the sensors may be placed in a variety of other locations within the vehicle as well. The radar sensors may be configured to detect the presence of occupants within the vehicle. These occupants may, for example, include the driver, passengers, children, or pets. Radar systems may monitor movement of the vehicle occupants, including breathing and other biometric markers like heart rate, and can identify when an occupant is left behind in the vehicle. The radar systems may further be connected to other systems within the vehicle, such as an electronic control unit (ECU), which may also connect to other systems within the vehicle capable of providing, for example, alerts or other notifications to a user of the vehicle regarding the sensor readings.

Radar systems can detect the presence of living beings within the vehicle by picking up on small movements. Radar systems may be used to prevent children or pets from being left unattended in a vehicle by alerting a user of the vehicle if something is detected inside the vehicle when the vehicle is locked. Radar systems may also be used to aid various passenger safety systems, including seatbelt reminders and airbag deployment management. Radar waves can penetrate through materials inside the vehicle such as the seats and can detect movement even when the person or the pet is not directly visible. Radar systems can also be combined with cameras and other sensors both inside and outside the vehicle in order to enhance vehicle safety.

Many current vehicle radar systems try to avoid window glass being in the signal path of the radar waves in order to prevent noise creation or other signal distortion caused by the radar waves interacting with objects or events outside the vehicle, such as rain. However, if a vehicle's radar system is configured to avoid the vehicle's windows, people or objects near the vehicle's windows may be missed by the radar system. For example, a passenger leaning on or toward a door window may be overlooked by an interior radar passenger detection system that is configured to avoid the windows in order to limit noise and signal degradation potentially caused by the

### Windows.

Radar absorbing material (RAM) may be used to increase the performance of interior vehicle radar systems without having to avoid windows. Instead, RAM may be applied onto or embedded or integrated into the windows themselves, limiting unwanted noise, reflections, absorptions, or other hindrances on system performance. RAM may also be added elsewhere within the vehicle, such as in the doors, floor, roof, sunroof, or other areas of the vehicle in order to limit the scope of the radar system to within the interior cabin of the vehicle and prevent unwanted reflections or other noise from outside the vehicle.

RAMs are designed to reduce the reflection of electromagnetic waves. Many RAMs absorb radar waves. Therefore, a RAM applied on or within the windows of vehicles may absorb radar waves that can have otherwise been reflected by or through the window to bring noise to the system's readings.

RAMs may include carbon-based materials like carbon composites and carbon nanotubes that are highly effective in absorbing radar waves, or other carbon-based materials like graphene. RAMs may also include conductive polymers like polyaniline and polypyrrole that can be used to create radar-absorbing coatings. Other RAMs include ferrites and other magnetic materials that can absorb radar signals by converting electromagnetic energy into heat. Additionally, RAMs may include resonant structures that resonate at specific radar frequencies and can be designed to absorb those frequencies effectively. Further, RAMs may include any material that is capable of absorbing radar in any way.

The systems, vehicles, and methods described herein apply RAM to or into the window glass of vehicles in order to increase the performance of vehicle radar systems. The vehicle may include a radar system with one or more radar sensors configured to detect one or more properties of the vehicle and its occupants. The vehicle may further have an electronic control unit (ECU) coupled to the radar system and configured to receive the detected properties from the radar sensors. The ECU may then prompt a number of different vehicle systems to respond, including alerts or other warnings. These alerts or warnings may include, for example, seatbelt reminders for passengers that the radar system has detected or alerts to a user of the vehicle that a person, a child, a pet, etc. has been left behind in the vehicle after the user has left the vehicle. These alerts may include visual warnings or auditory alerts and may be sent to a user of the vehicle through other connected devices, such as the user's mobile device or phone.

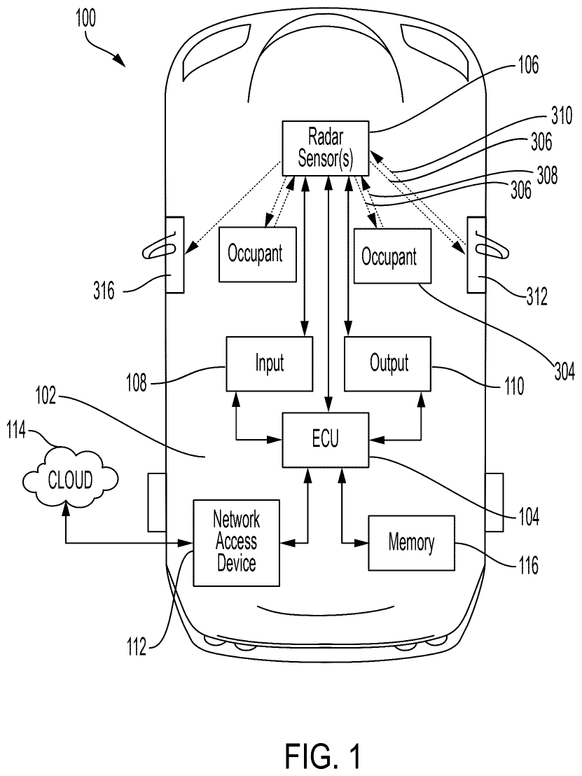

FIG. 1 illustrates a vehicle 100. The vehicle 100 is a conveyance capable of transporting a person, an object, pets or other animals, or a permanently or temporarily affixed apparatus. The vehicle 100 may have an automatic or manual transmission. The vehicle 100 may be a self-propelled wheeled conveyance, such as a car, an SUV, a truck, a bus, a van, or other motor or battery driven vehicle. For example, the vehicle 100 may be an electric vehicle, a hybrid vehicle, a plug-in hybrid vehicle, a fuel cell vehicle, or any other type of vehicle that includes a motor/generator.

The vehicle 100 may be non-autonomous, fully autonomous, or semi-autonomous. In that regard, the ECU 104 may control various aspects of the vehicle 100 (such as steering, braking, accelerating, or the like) to maneuver the vehicle 100 from a starting location to a destination location. In some embodiments, the vehicle 100 may be operated in an autonomous, semi-autonomous, or fully driver-operated state. In that regard, the vehicle 100 may be operated independently of driver control and, from time to time, without a person inside of the vehicle 100. The ECU 104 may facilitate such autonomous functionality.

The vehicle 100 (or in some embodiments a system 100) may include a radar system 102. The radar system 102 may include or connect to an electronic control unit (ECU) 104 that connects to other parts of the system. The ECU 104 may connect to one or more radar sensors 106, an input device 108, an output device 110, a network access device 112 that can connect to a cloud 114, and a memory 116.

The ECU 104 may be coupled to each of the components of the vehicle 100 and can include one or more processors or controllers which may be specifically designed for automotive systems. The functions of the ECU 104 can be implemented in a single ECU or in multiple ECUs. The ECU 104 may receive data from the components of the vehicle 100, may make determinations based on the received data and may control the operation of the components of the vehicle 100 based on the determinations and the received data.

The radar sensor 106 may include any radar sensor capable of detecting data corresponding to an aspect of the vehicle 100. The radar sensor 106 may include an emitter, a detector, a transmitter, a receiver, a sensor, and/or a radar. The radar sensor 106 may, for example, be configured to detect the presence of, location of, or motion of occupants of the vehicle 100. The radar sensor 106 may be located inside or within the vehicle 100 or may be located outside the vehicle or on the vehicle's exterior. The radar sensor 106 may be coupled to the vehicle 100. The radar sensor 106 may include one or more radar sensors. The radar sensor 106 may be configured to send its sensor data to the ECU 104.

The memory 116 may include any non-transitory memory known in the art. The memory 116 may store machine-readable instructions usable by the ECU 104 and may store any other data as requested by the ECU 104. For example, the memory 116 may store map data, may store instructions usable by the ECU 104 to drive autonomously, may store data indicating actions to be taken by the ECU during various environmental conditions, may store sensor data from the radar sensor 106, may store what responses to prompt in response to received sensor data, may store data from the input device 108, or the like.

The network access device 112 may include any device capable of communicating with an external device or a network. For example, the network access device 112 may communicate with the cloud 114 via 3G protocols, 4G protocols, 5G protocols, 802.11 (Wi-Fi) protocols or the like.

In some embodiments, the network access device 112 may also or instead include an input/output (I/O) port. In that regard, the network access device 112 may connect to other vehicles or devices (not shown) via a wired or wireless interface. For example, the network access device 112 may be a USB port, a Wi-Fi port, a Bluetooth port, a Dedicated Short-Range Communications (DSRC, usable in vehicle-to-infrastructure or vehicle-to-vehicle communications) port or the like. The network access device 112 may transmit data to and receive data from an external device such as a mobile phone (not shown) or a telematics device (not shown), which may in turn communicate with the cloud 114 or other vehicles (not shown). In that regard, the ECU 104 can communicate with the cloud 114 via the network access device 112 and the mobile device or phone.

The input device 108 may include any input device capable of receiving user input. For example, the input device 108 may include a button, a knob, a dial, a touchscreen, a touchpad, a microphone, or the like. The input device 108 may be coupled to the ECU 104 such that the ECU 104 can receive user input. The input device 108 may include any component of the vehicle that a user of the vehicle interfaces with. For example, the input device 108 may include a driver seat, a steering wheel, mirrors, a heating ventilation and air conditioning (HVAC) system, a telematics unit (including Bluetooth connectivity and/or an audio system), a navigation device or system, an autonomous driving system or a semi-autonomous driving system, or the like.

The input device 108 may include any input device that a driver or user of the vehicle 100 may use to change settings of the vehicle 100. For example, the input device 108 may include a set of knobs or dials coupled to the driver's seat that can be used to change the position of the driver's seat. The input device 108 may also or instead include one or more of a device for changing a position of the steering wheel, a knob or dial for changing a position of the mirrors, a touchscreen or other interface for controlling the HVAC, the telematics unit, the navigation device or system, the autonomous driving system and/or the semi-autonomous driving system or the like.

The output device 110 may include any output device capable of outputting data to a user. For example, the output device 110 may include a speaker, a display, a touchscreen, a refreshable braille display or the like. The output device 110 may be capable of interfacing with external devices (not shown) such as a mobile device or phone operated by a user of the vehicle 100.

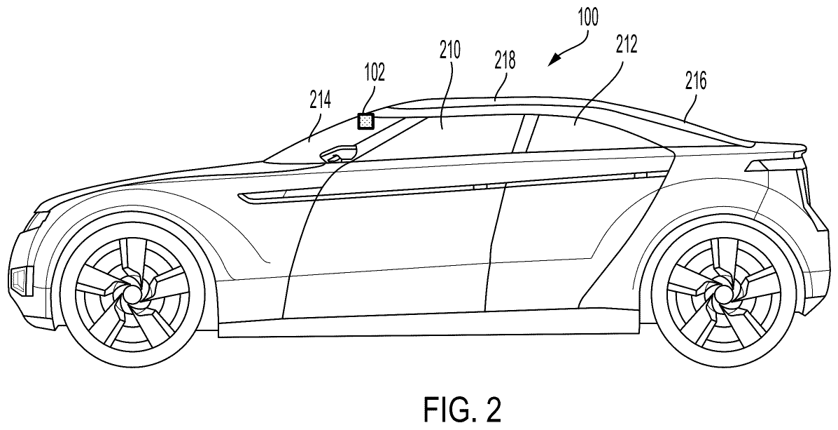

FIG. 2 illustrates the vehicle 100 with the radar system 102. The radar system 102 may be located within an overhead console or roof lining near the front of the vehicle cabin, as shown. For example, the radar system 102 may be located near the driver (e.g., in the center front top ceiling) and directed such that the radar waves are projected in a rear direction inside the vehicle 100. In other embodiments, one or more radar systems 102 may be located within the vehicle 100 in other locations, including, but not limited to, near the rear of the vehicle cabin, near the center of the vehicle cabin, and/or on either side of the vehicle cabin.

The vehicle 100 may have one or more front side windows 210, one or more rear side windows 212, one or more front windows 214, one or more rear windows 216, and one or more sunroof (or moonroof or panoramic glass ceiling panel) 218. One or more of the front side windows 210, rear side windows 212, front windows 214, rear windows 216, and sunroof 218 may be treated with one or more RAMs. The RAM may be embedded into, incorporated into, molded into, other otherwise manufactured into the glass or applied to a surface of any of the windows, such as in a coating, film, or other treatment. The RAM may also or alternatively be integrated into the material matrix of the window glass, such as added as a liquid, powder, or other additive to the window resin as the window is formed.

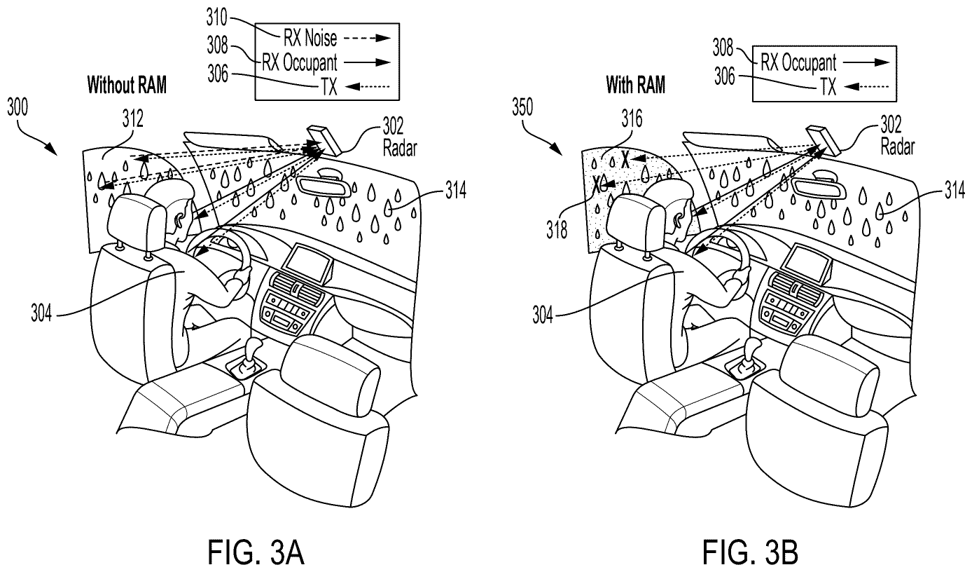

FIG. 3A illustrates a vehicle interior 300 with a radar system 302 and a passenger 304. The radar system 302 may include an emitter, a detector, a transmitter, a receiver, a sensor, and/or a radar. The radar system 302 emits one or more transmit (TX) signals 306 and receives one or more receive (RX) signals 308 as well as noise 310. The vehicle interior 300 may include a window 312 that is not treated with any RAM. The rain 314 outside the vehicle is detectable through the windows of the vehicle, including window 312. The rain 314 can add to noise generated by the radar system 302.

The radar system 302 may send out the transmit signals 306 and may receive back the receive signals 308. If the radar system 302 is an occupant detection system, such as shown in FIGS. 3A and 3B, then the receive signals 308 will be occupant detection signals. The radar system 302 may also receive back noise signals 310. Noise may be generated through a variety of means. As shown in FIG. 3A, noise 310 may be generated through the transmit signals 306 interacting with the rain 314 through the window 312.

FIG. 3B illustrates a vehicle interior 350 with the radar system 302 and the passenger 304. The radar system 302 emits the transmit signals 306 and receives the receive signals 308. The vehicle interior 300 may include a window 316 that is treated with one or more RAMs. The rain 314 exists outside the vehicle 100. However, noise generated by the radar system 302 due to the rain 314 is limited because the RAM applied to or within the window 316 absorbs the radar waves that could have reflected off the rain 314 to generate the noise.

FIG. 3B illustrates the instances of prevented noise creation at the window 316 by X's 318 which represent absorbed or blocked potential noise reflections. While FIG. 3B illustrates the window nearest to the passenger 304 as being the window 316 treated with RAM, other or additional windows of the vehicle may also be treated with RAM. The window 316 treated with one or more RAMs is able to improve the performance of the radar system 302 by preventing noise, seen in the representative absorbed or blocked potential noise reflections shown in X's 318, which can reduce false readings and increase the clarity of the receive signals 308 that are received by the radar system 302. The window 316 treated with one or more RAMs is also able to improve the performance of the radar system 302 by preventing any need to avoid the vehicle windows in order to prevent noise creation. Thereby, the RAM-treated window 316 is also able to increase the usable range or scope of the radar system 302.

Exemplary embodiments of the methods/systems have been disclosed in an illustrative style. Accordingly, the terminology employed throughout should be read in a non-limiting manner. Although minor modifications to the teachings herein will occur to those well versed in the art, it shall be understood that what is intended to be circumscribed within the scope of the patent warranted hereon are all such embodiments that reasonably fall within the scope of the advancement to the art hereby contributed, and that that scope shall not be restricted, except in light of the appended claims and their equivalents.

What is claimed is:

1. A vehicle having a radar system, the vehicle comprising:
a cabin configured to hold at least one occupant;
at least one window located on a side of the cabin;
a radar sensor positioned within the cabin and configured to emit electromagnetic waves and receive reflected signals within the cabin to detect the at least one occupant; and
a radar absorbing material on or within the at least one window, the radar absorbing material configured to reduce noise or false readings received by the radar sensor by absorbing and/or attenuating incoming electromagnetic waves, thereby reducing an amount of the electromagnetic waves that reflect off or through the at least one window.

2. The vehicle of claim 1, wherein the radar absorbing material is applied on a surface of the window.

3. The vehicle of claim 1, wherein the radar absorbing material is incorporated into a material composition of the window.

4. The vehicle of claim 1, wherein the radar absorbing material is a carbon-based material configured to absorb radar waves.

5. The vehicle of claim 4, wherein the radar absorbing material is a graphene film.

6. The vehicle of claim 1, wherein the radar absorbing material is a radar-absorbing coating comprising a conductive polymer.

7. The vehicle of claim 1, wherein the radar absorbing material is a magnetic material configured to convert electromagnetic energy into heat.

8. The vehicle of claim 1, wherein the radar absorbing material is a resonant structure configured to resonate at a specific frequency designed to absorb a radar frequency.

9. The vehicle of claim 1, wherein the radar absorbing material comprises two or more of:
a carbon-based material configured to absorb radar waves,
a radar-absorbing coating comprising a conductive polymer,
a magnetic material configured to convert electromagnetic energy into heat, and
a resonant structure configured to resonate at a specific frequency designed to absorb a radar frequency.

10. The vehicle of claim 1, wherein the at least one window is located on a left side of the vehicle, on a right side of the vehicle, on a front of the vehicle, on a rear of the vehicle, and/or on a roof of the vehicle.

11. The vehicle of claim 1, further comprising an electronic control unit (ECU) coupled to the radar sensor, wherein the ECU is configured to receive information from the radar sensor and transmit a notification regarding the information.

12. The vehicle of claim 1, further comprising an additional radar absorbing material located within the cabin of the vehicle and configured to absorb electromagnetic waves and reduce noise received by the radar sensor.

13. A vehicle equipped with a radar system, the vehicle comprising:
a radar sensor configured to send and receive radar signals to detect a property of an interior of a vehicle;
an electronic control unit (ECU) coupled to the radar sensor and configured to:
receive information regarding the detected property; and
prompt a response; and
a radar absorbing material on or within at least one window of the vehicle and configured to absorb the radar signals from the radar sensor.

14. The vehicle of claim 13, wherein the property detected by the radar sensor comprises a presence of an occupant detected by one or more biometric markers.

15. The vehicle of claim 13, wherein the property detected by the radar sensor comprises a movement of an occupant or object within the vehicle.

16. The vehicle of claim 13, wherein the response of the ECU comprises management of one or more safety features.

17. The vehicle of claim 13, wherein the response of the ECU comprises an alert to a user or passenger of a vehicle.

18. The vehicle of claim 13, wherein the radar absorbing material is a coating or a film applied to an interior and/or exterior of the at least one window of the vehicle.

19. The vehicle of claim 13, wherein the radar absorbing material is one or more materials incorporated into a material matrix of the at least one window of the vehicle.

20. The vehicle of claim 13, wherein the radar absorbing material is configured to reduce an amount of radar signals received by the radar sensor due to water located outside the vehicle.
